(19) United States
(12) Patent Application Publication
(10) Pub. No.: US 2006/0053473 A1
(43) Pub. Date: Mar. 9, 2006

(54) System and method of image distribution

(76) Inventors: Jean-Marie Vau, Paris (FR); Olivier L. Seignol, Champs sur Marne (FR)

Correspondence Address: BETH READ;PATENT LEGAL STAFF, EASTMAN KODAK COMPANY, 343 STATE STREET, ROCHESTER, NY, 14650-2201, US

(21) Appl. No.: 10/538,435

(22) PCT Filed: Nov. 22, 2003
(86) PCT No.: PCT/EP03/13129

§ 371 Date: Jun. 10, 2005

(30) Foreign Application Priority Data
Dec. 11, 2002 (FR) 02/15616

(51) Int. Cl. H04N 7/173; H04N 7/16

(52) U.S. Cl. 725/144; 725/114; 725/146

(57) ABSTRACT

The invention relates to a method of image distribution from a central distribution server (10) to at least one receiver device (20), in which, in response to a user request, at least one image is transmitted by a telecasting means, and an information message of image availability by telecasting is sent to the receiver device (20).

### FIELD OF THE INVENTION

The present invention relates to a system and method of image distribution, and in particular of photographs. Notably it has applications in the field of network digital image management services. An image management service means a service, provided by an operator, that consists essentially in receiving images, saving them in digital format, and providing controlled broadcasting, e.g. on a communications network.

### BACKGROUND OF THE INVENTION

Because of their digital weight, managing digital images can have some difficulties for users. Indeed, image processing and conservation require considerable calculation and memory capacities. Therefore, some operators offer on-line conservation and management services.

As stated above, image management services essentially comprise the saving of digital images, if necessary obtained after digitizing silver images, and image broadcasting. These operations essentially make use of a central server, provided with memory facilities. Each user can have a memory space similar to a photo album. Remote consultation is possible through network communication. In particular, the routing of images to the server and from the server can take place as image files sent on the Internet.

Further, electronic image receiver devices are known, e.g. as digital photo frames comprising a display screen. These portable devices have a network communication channel. They enable the reception, by Internet, of images from the server of an image management services provider. The network communication channel comprises in particular a telephone network connection, wired or wireless, so as not to be bound to a table model.

A user, service subscriber, can share images with colleagues having such a frame, or any other IT equipment with a network connection. In particular they can do this by addressing an order to select and send images to the service provider. The selected images are then downloaded from the server to the addressees, by the communications network.

The remote management of images according to the method mentioned above, however, has some difficulties. A first difficulty is linked to the transfer of images from the central server to the receiver devices. Indeed, the digital weight of the transferred images does not enable their immediate availability and gives rise to a certain transfer cost. In particular, the usual telephone network is not very suitable for the immediate transmission of digital files containing images. To get around this difficulty, the user can, for example, plan the transfer of images at given times, preferably at night, to reduce the transmission costs. However, the offsetting of the moment of image transfer is not compatible with optimal comfort in using the receiver device.

The user can also subscribe to a broadband data transfer service to obtain images almost-instantaneously. However, such a subscription is usually monthly, and also has a significant cost It is not suited to simply occasional consultation of the images available on the server.

### SUMMARY OF THE INVENTION

The purpose of the present invention is to provide a method and a system of digital image distribution, and especially photographic images, not having the difficulties and limits mentioned above.

One aim is especially to make available to varied users, good resolution images, while avoiding the limits imposed by data transmission by telephone network or by telephone access network.

Another aim is also to enable rapid and instantaneous transfer of images for their comfortable consultation.

It is also an aim of the invention to save the user of a digital receiver photo frame from subscribing to broadband Internet access.

Finally, it is an aim of the invention to provide a simple means ensuring the payment of the image distribution service.

To achieve these aims, an object of the invention is more precisely a method of image distribution from a central distribution server to at least one receiver device, in which, in response to a user request, at least one image is distributed by a telecasting means, and an information message of image availability by telecasting is sent to the receiver device.

By telecasting means is meant any telecasting means of the type used to broadcast televised or radio programs. In particular, the telecasting means can include radio type AM/FM, UHF/VHF broadcasting, or by satellite, as well as broadcasting means by electric cable or optical fiber. The term “telecast” is taken here also to cover radiocasting.

According to a special implementation of the method, the central server receives an image distribution request, from a user, as an electronic message transmitted by the network. For example, by Internet or by telephone. The requester's message contains at least one address or a pointer to one or more images stored, digitally, in a memory linked to the server. This image is then transmitted from the server to a telecasting station capable of distributing the image using the means mentioned above.

The server can be directly linked to the telecasting station or can be linked to it by a broadband communication network. The broadcasting operation can then be subcontracted to a television operator, for example.

Further, the availability information message lets the image addressee start to receive the telecast image data. This may take place automatically or not, using a suitable receiver device. As an example, the reception of the message can be used to cause the powering up of a radio receiver tuned to a frequency appropriate to the telecasting station. Data relating to the selected image or images are then captured.

According to an improvement of the invention, especially intended to ensure selection of image addressees, the image can be encoded with one or more keys. The encoding takes place before broadcasting, to prohibit its decryption by unauthorized persons.

The key can be a key previously made available to certain potential addressees. Nevertheless, according to a preferred implementation of the invention, the key can be transmitted with the availability information message. This enables the use of a different key for each image or image group, and thus increases transmission security.

Image transmission to the telecasting station and that of the availability information message to the receiver device can take place offset in time. However, it is preferred to perform the two transmissions more or less at the same time, to not block the telecast station or delay image reception by the addressee. In fact the image data are broadcast continuously, or intermittently, from the telecasting station.

Another measure, also intended to reduce transmission station blocking, consists in planning the transmission of an image acknowledgement by the receiver device, as soon as the transmitted image(s) reception is complete. The acknowledgement can be sent to the telecasting station by means of the central server. It is used to interrupt the broadcast of the image. Thus the image is only present on the broadcast band between the moment of the transmission of the availability information message and the reception of the acknowledgement message.

Several mechanisms of payment of the image distribution service can be planned. According to a particular aspect of the invention, payment can be made when a user sends a distribution request. This request can be sent to the server by an electronic message, for example surcharged SMS type (Short Message Service). In this way the price of later processing, including that of the image telecasting is included in the price of the request message.

The invention also relates to an image broadcasting system comprising an image distribution central server, a first communication link between the server and a telecasting station and a second communication link between the central server and a receiver device, the receiver device being capable of receiving a telecast signal from the telecasting station.

The receiver device can include a television set, a digital camera or any other device capable of displaying an image.

The receiver device is, for example, a digital photo frame.

Finally the invention relates to a digital photo frame comprising a network communication channel, a telecast signal reception channel, and display means of an image received by the telecast signal reception channel, in response to an availability information message received by the network communication channel.

For the reception of encoded images, the telecast signal reception channel can be provided with a key decoder to decode the encoded telecast image signals (encrypted) with a key. The key can be transmitted by the network communication channel or by any other means.

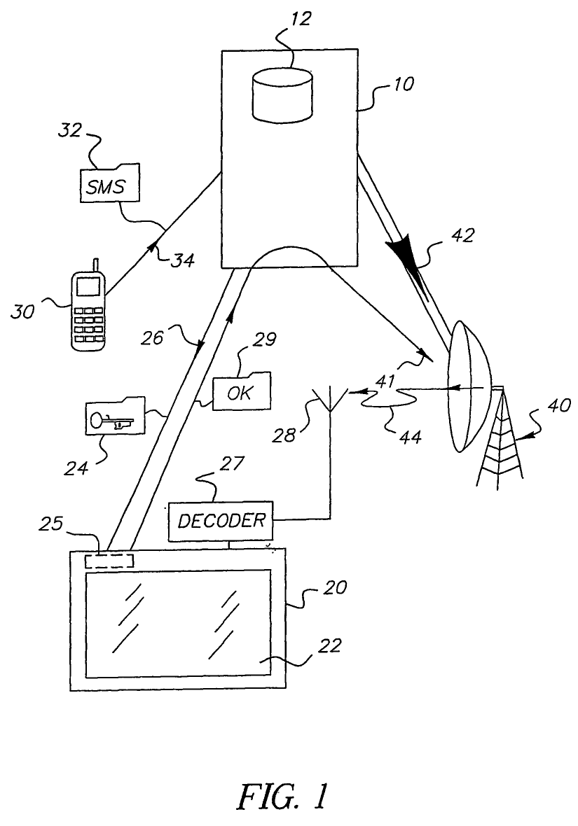

Other characteristics and advantages of the invention will appear in the following description, with reference to FIG. 1 of the appended drawing. This description is given purely as an illustration and is not limiting.

### DETAILED DESCRIPTION OF THE INVENTION

FIG. 1 in annex is a diagrammatic illustration of an image broadcasting system according to the invention. It also illustrates a special implementation of an image broadcasting process according to the invention. For purposes of clarity, the various parts of the figure are simplified and illustrated with no set scale.

Reference 10 of the figure designates a central server used by an image management service provider. The server comprises or is linked to a memory 12 in which images, and especially photographs, are stored as digital data.

Image data recorded in the memory 12 are assigned to one or more users who can consult them remotely, for example, by means of a communication network like Internet The user can also request the transfer of one or more images from the server 10 to a receiver device 20 of one or more addressees of their choice.

The receiver device 20 is, in the example shown, a digital photo frame provided essentially with a display screen 22. The screen 22 enables the display of the images or photographs and presents them like a conventional photo frame.

The transfer request issued by the user can be sent by the communication network as an electronic message (SMS—Short Message Service) 32. The message is sent, for example, from a mobile phone 30 having Internet access. The single arrow 34 symbolizes this transfer by the network with telephone access. The transmission can be handled by other intermediary devices not shown. Access to the communication network can also be handled by any other means. In addition, any equipment having a modem or not can be used to generate the transmission request message 34. The message can, for example, be generated by a PC.

The distribution request message is used to identify the images to be transferred. It can also be used for the distribution service payment. In the latter case the message 32 is a surcharged message.

On reception of the transfer request message, the server 10 identifies the requested images, retrieves them from the memory 12 and formats them to route them to a telecasting station 40. Routing the images to the telecasting station, shown symbolically by a double arrow 42, can take place by a direct connection or also by the communication network. In the latter case broadband access is used.

Routing the images to the telecasting station 40 can be accompanied by an image encoding (encryption) key. Thanks to this key, the image is encoded, formatted and finally telecast. In particular the image can be telecast as data packets corresponding to parts of the image.

The central server transmits, simultaneously or not, an availability information message 24 to the digital frame 20. For example this is SMS type (Short Message Service). The digital frame 20 receives this message on a network communication channel having an SMS radio module 25. The SMS module can be replaced by a modem. Transmission of the availability information message 24 is handled by a communications network and is symbolized by an arrow 26. The availability information message 24 can be used as the vector of the key used for encoding the image to be transferred. The availability information message is also used to trigger the reception of the telecast image data, and their decoding if necessary. Reference 27 designates a decoder linked to the receiver device. For example this is a conventional television decoder (set top box). The decoder 27, linked to an antenna 28, enables the image data to be reproduced. These are temporarily saved in a buffer memory, not shown, of the device 20.

After full reception of the data relating to the transmitted image, an acknowledgement message 29 is transmitted by the receiver device 20. As shown by the arrow 41, the message is transmitted to the central server 10, and then, by means of this server, to the telecasting station. Reception of the acknowledgement message 29 is used to interrupt the telecasting of the data related to the image received on the receiver device. In particular this measure enables the telecasting station not to be blocked.

An arrow with the reference 44 symbolizes radio transmission, or, alternatively, cable transmission. It takes place between the telecasting station and one or more receiver devices.

The single line arrows 26, 34 & 41 relate to network transmissions, for example by Internet, with summary access, such as telephone access. However, this does not exclude the option of using broadband access. However, the double arrow 42 designates a link authorizing fast transmission of large volumes of image data.

What is claimed is:

1. A method of image distribution from a central distribution server (10) to at least one receiver device (20), in which, in response to a user request at least one image is broadcast by a telecasting means, and an information message (24) of image availability by telecasting is sent to the receiver device (20).

2. A method according to claim 1, wherein the image to be broadcast is transmitted from the server to a telecasting station (40).

3. A method according to claim 1, wherein the image is encoded with at least one key before its broadcasting.

4. A method according to claim 2, wherein the key is sent to the receiver device (20) with the availability information message (24).

5. A method according to claim 1, wherein transmission of the image to the telecasting station and transmission of the availability information message (24) to the receiver device take place more or less at the same time.

6. A method according to claim 1, comprising the transmission by the receiver device (20), of an acknowledgement (29) of the image and the interruption of the broadcasting of the image in response to the acknowledgement.

7. A method according to claim 1, wherein the availability information message (24) and/or acknowledgement are messages transmitted by Internet.

8. A method according to claim 1, wherein the image is broadcast by radio and/or by cable.

9. A method according to claim 1, wherein the image distribution request is transmitted from the user to the central server using a surcharged electronic message (32).

10. An image distribution system comprising a central server (10), a first communication link (42) between the server and a telecasting station and a second communication link (26) between the central server and a receiver device (20), the receiver device being capable of receiving a telecast signal (44) from the telecasting station.

11. A system according to claim 10, wherein the receiver device comprises a television set, a digital camera or any other device capable of displaying an image.

12. A system according to claim 10, wherein the receiver device is a digital photo frame.

13. A digital photo frame comprising a network communication channel, a telecast signal reception channel (27, 28), and display means (22) of an image received by the telecast signal reception channel, in response to an information message received by the network communication channel.

14. A frame according to claim 13, wherein the telecast signal reception channel has a key decoder (27).
